(19) United States
(12) Patent Application Publication
(10) Pub. No.: US 2024/0278309 A1
(43) Pub. Date: Aug. 22, 2024

(54) METHOD FOR MAKING A BATTERY CAN FOR P-TYPE PRISMATIC CELLS

(71) Applicant: GM GLOBAL TECHNOLOGY OPERATIONS LLC, Detroit, MI (US)

(72) Inventors: Wai Ping Gloria Tam, Troy, MI (US); David F. Titmuss, Commerce Township, MI (US); Noel Alvarez Aguilar, Washington Township, MI (US)

(73) Assignee: GM GLOBAL TECHNOLOGY OPERATIONS LLC, Detroit, MI (US)

(21) Appl. No.: 18/171,000

(22) Filed: Feb. 17, 2023

(51) Int. Cl. B21D 51/28; B21D 5/16; B23K 26/38; H01M 50/103; H01M 50/124; H01M 50/30

(52) U.S. Cl. CPC B21D 51/28; B21D 5/16; B23K 26/38; H01M 50/103; H01M 50/1243; H01M 50/1245; H01M 50/30; H01M 2200/20

(57) ABSTRACT

A method for making a battery can, for example, but not limited to, for a p-type prismatic cell may include: manufacturing at least one first battery can portion and at least one second battery can portion, using a first manufacturing process; joining the at least one first battery can portion and the at least one second battery can portion, using a second manufacturing process, different from the first manufacturing process; and inspecting the battery can to verify the joining between the at least one first portion and the at least one second portion. A method for making a battery can may include: providing at least one safety vent in a battery can and/or applying an insulation coating to one or more of an internal surface, an external surface and at least one seam of the battery can.

### INTRODUCTION

The concepts described herein relate generally to electrochemical battery cells including, but not limited to, methods of making metal enclosures or “cans,” used in the manufacture of P-type prismatic battery cells.

A prismatic battery cell generally includes an electrode “stack,” disposed within a metal can, which is generally rectangular in shape. The electrode stack is made up of positive electrodes (cathodes), negative electrodes (anodes) and a separator layer or layers sandwiched together. The stack may also be rolled into a modified jelly roll prior to being disposed within the metal can. Prismatic battery cells are typically stacked in columns and are often used in electric vehicles.

A P-type prismatic battery cell includes a positive terminal and a negative terminal, which are co-planar with one another and located on a common side of a final electrochemical battery cell assembly.

Conventional metal cans for P-type prismatic cells are manufactured using a deep drawing method, which is a sheet metal forming process in which a sheet metal blank is drawn into a forming die by the mechanical action of a punch. This process is considered to be “deep” drawing with a depth of the drawn part exceeds its diameter.

The deep drawing method has disadvantages and/or limitations, which may include, but are not limited to, wrinkling, fracturing and/or cracking, uneven wall thickness, and a limited overall length and/or depth.

Due to the overall length limitation associated with deep drawing, a conventional metal battery can, made using deep drawing, is limited to approximately between 300 millimeters and 350 millimeters in length, which in turn limits the length or size of the P-type prismatic cell.

Accordingly, P-type prismatic cells, including metal cans having a length limited by the conventional deep drawing method, may have a limited cell energy density, which may result in increased battery pack weight and decreased mileage performance in an electric vehicle.

### SUMMARY

An electrochemical battery cell generally includes: an electrode assembly, a liquid electrolyte, a metallic battery enclosure or “can” containing the electrode assembly and the liquid electrolyte.

In one non-limiting embodiment of the present disclosure, a method for making a battery can, for example, but not limited to, a battery can for a p-type prismatic cell may include: identifying an internal battery volume; generating a prismatic model of the battery can, wherein the battery can includes a first portion having a first contour and a second portion having a second contour; producing a first portion blank and a second portion blank, using a first manufacturing process; modifying the first portion blank and the second portion blank, using a second manufacturing process, to create the first contour and the second contour; joining the first portion having the first contour and the second portion having the second contour, using a third manufacturing process; and inspecting the battery can to verify joining between the first portion and the second portion.

In one non-limiting example of the present disclosure, the second manufacturing process is different from the first manufacturing process. That is, the first manufacturing process may be a cutting process, for example, but not limited to, a high precision cutting process, and the second manufacturing process may be, for example, but not limited to, a folding process.

The cutting process may produce at least a first portion blank and a second portion blank. The first portion blank and the second portion blank may be fabricated from a metal sheet, which may provide a uniform wall thickness of the battery can.

The folding process may include a die bending process that may form at least one flange on the first portion blank, to create a first contour, and at least one flange on the second portion blank, to create a second contour. The die bending process may reduce corner radius limitations of the battery can, potentially increasing battery cell capacity through increased electrode stack sizes.

In one non-limiting example, the first portion blank may have a bottom edge portion bent to form a flange to create the first contour, while the second portion blank may have opposing side portions bent to form two flanges to create the second contour.

In one non-limiting embodiment of the present disclosure, a method for making a battery cell may include verifying the first contour of the first portion substantially matches the second contour of the second portion, prior to joining the first portion and the second portion, using the third manufacturing process.

In one non-limiting example of the present disclosure, the third manufacturing process may be, but is not limited to, a laser welding process.

Joining the first portion and the second portion may include creating seams between the first portion and the second portion of the battery can.

Inspecting the battery can may include verifying that the battery can is hermetically sealed at the seams between the first portion and the second portion of the battery can.

In another non-limiting embodiment of the present disclosure, a method identifying the internal battery volume may be based upon a target capacity.

In one non-limiting embodiment of the present disclosure, a method of making a battery cell may include providing at least one safety vent in the battery can.

Providing the at least one safety vent in the battery can may include: determining at least one location for the at least one safety vent, preparing the battery can for installation of the as least one safety vent; and installing the at least one safety vent.

In one non-limiting example of the present disclosure, the at least one safety vent may be installed in at least one of the first portion and the second portion of the battery can, which may provide improved thermal runaway protection/propagation strategies.

In a non-limiting embodiment of the present disclosure, a method of making a battery cell may include applying an insulation coating to the battery can.

The insulation coating may be applied to one or more of an inside surface of the battery can, an outside surface of the battery can, an internal seam and/or an external seam of the battery can.

In one non-limiting example of the present disclosure, an insulation coating may be applied on an inside surface of at least one of the first portion and the second portion of the battery can.

The insulation coating may be applied prior to joining the first portion and the second portion, which may simplify a battery cell manufacturing process.

The insulation coating may be applied, for example, but not limited to, by brushing or spraying followed by drying in an oven to achieve a required coating thickness.

In another non-limiting embodiment of the present disclosure, a method for making a battery can, for example, but not limited to, for a p-type prismatic battery includes: identifying battery can dimensions and features, including a battery can length; providing an extrusion die with a channel opening and features that correspond with the identified battery can dimensions and features; extruding a metal material through the extrusion die to form a battery can extrusion; cutting the battery can extrusion into at least one battery can extrusion portion having the identified battery can length; stamping at least one stamped metal portion, using a stamping process; joining the at least one stamped metal portion to the at least one battery can extrusion portion, using a laser welding process; and inspecting the battery can to verify joining between the at least one stamped metal portion and the at least one battery can extrusion portion.

Extruding a metal material through an extrusion die to form the at least one battery can extrusion may provide a uniform wall thickness and reduced radius limitations of the battery can.

The at least one battery can extrusion may be cut into battery can extrusion portions, each having a length that may be greater than 350 millimeters.

In one non-limiting example of the present disclosure, the at least one battery can extrusion portion may include two side openings.

Joining the at least one stamped metal portion to the at least one battery can extrusion portion may include joining two stamped metal portions to the at least one battery can extrusion portion, such that one of the two stamped metal portions may be joined to one of the two side openings and the other of the two stamped metal portions may be joined to the other of the two side openings.

In one non-limiting example of the present disclosure, joining the at least one stamped metal portion to the at least one battery can extrusion portion may include joining two battery can extrusion portions to one another to form a substantially rectangular metal tube. The at least one stamped metal portion may be joined to the substantially rectangular metal tube.

In one non-limiting example of the present disclosure, joining the at least one stamped metal portion to the at least one battery can extrusion portion may include creating seams between the at least one stamped metal portion and the at least one battery can extrusion portion.

Inspecting the battery can may include verifying that the battery can is hermetically sealed at the seams between the at least one stamped metal portion and the at least one battery can extrusion portion.

In one non-limiting embodiment of the present disclosure, a method of making a battery cell may include providing at least one safety vent in the battery can, which may provide improved thermal runaway protection/propagation strategies.

Providing the at least one safety vent in the battery can may include: determining at least one location for the at least one safety vent, preparing the battery can for installation of the at least one safety vent; and installing the at least one safety vent.

In one non-limiting example of the present disclosure, the at least one safety vent may be installed in at least one battery can extrusion portion of the battery can.

In one non-limiting embodiment of the present disclosure, a method of making a battery cell may include: applying an insulation coating to the battery can.

The insulation coating may be applied to one or more of an inside surface of the battery can, an outside surface of the battery can, an internal seam and/or an external seam of the battery can.

In one non-limiting example of the present disclosure, an insulation coating may be applied on an inside surface of at least one of the at least one stamped metal portion and the at least one battery can extrusion portion. In a non-limiting embodiment of the present disclosure, a method of making a battery cell may include applying an insulation coating to the battery can.

In one non-limiting example of the present disclosure, an insulation coating may be applied prior to joining the at least one stamped metal portion and the at least one battery extrusion portion, which may simplify a battery cell manufacturing process.

In one non-limiting example of the present disclosure, an insulation coating may be applied prior to joining the two battery extrusion portions to form the battery extrusion portion, which may simplify a battery cell manufacturing process.

The insulation coating may be applied, for example, but not limited to, by brushing or spraying followed by drying in an oven to achieve a required coating thickness.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 is an exploded view of an example battery can, in accordance with the present disclosure.

FIG. 2 is a close up view of a section of one end of an example battery can, in accordance with the present disclosure.

FIG. 3 is a flow chart describing one example method for making a battery can, in accordance with the present disclosure.

FIG. 3A is a flow chart describing one example method of providing at least one safety vent in a battery can, in accordance with the present disclosure.

FIG. 4 is an exploded view of an example battery can, in accordance with the present disclosure.

FIG. 5 is an illustration of an example battery can, in accordance with the present disclosure.

FIG. 6 is an illustration of an exploded view of an example battery can, in accordance with the present disclosure.

FIG. 6A is an illustration of an example battery can, in accordance with the present disclosure.

FIG. 7 is a flow chart describing one example method of making a battery can, in accordance with the present disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

Referring now to the drawings, wherein like numerals indicate like parts in several views, a battery can, including at least a first portion and a second portion manufactured using at least two manufacturing processes, which are different from one another, and methods for making the battery can, are shown and described herein.

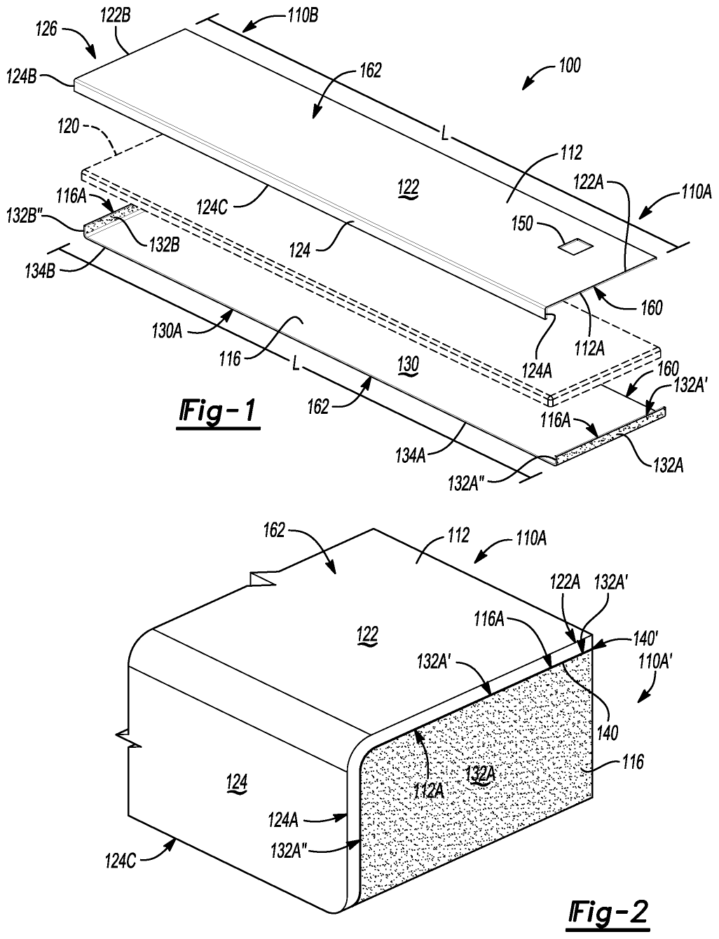

As illustrated in FIG. 1, an exploded view of a battery can 100, in accordance with the present disclosure, includes a side portion 110A, a side portion 110B, a first portion 112 having a first contour 112A, and a second portion 116 having second contour 116A. The first portion 112 and the second portion 116 may define an internal battery volume 120.

The first portion 112 includes a first portion blank 122 having a flange 124 formed at a bottom portion 126. The first portion blank 122 includes a first side edge portion 122A and second side edge portion 122B. The flange 124 includes a first flange edge portion 124A, extending downward from the first side edge portion 122A of the first portion blank 122, a second flange edge portion 124B, extending downward from the second side edge portion 122B of the first portion blank 122, and a third flange edge portion 124C, extending between the first flange edge portion 124A and the second flange edge portion 124B of the flange 124.

The first contour 112A, of the first portion 112, is defined by the first side edge portion 122A of the first portion blank 122, the first flange edge portion 124A of the flange 124, the third flange edge portion 124C of the flange 124, the second flange edge portion 124B of the flange 124 and the second side edge portion 122B of the first portion blank 122.

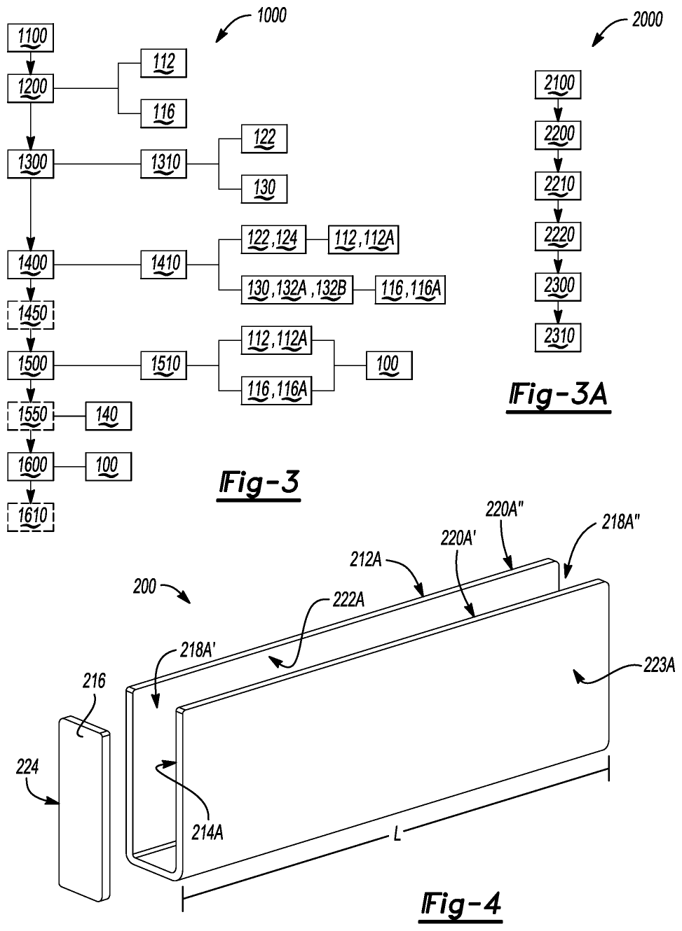

As illustrated in FIG. 3, the first portion blank 122 and the second portion blank 130 are produced using a first manufacturing process 1310 to have a length L that may be greater than 350 millimeters.

Referring back to FIG. 1, the second portion 116 includes a second portion blank 130 having two flanges 132A, 132B formed at opposing side portions 134A, 134B of the second portion blank 130.

The second portion blank 130 includes a bottom edge portion 130A.

Each of the two flanges 132A, 132B respectively includes a side edge portion 132A′, 132B′ and a bottom edge portion 132A″, 132B″.

The second contour 116A, of the second portion 116, is defined by the side edge portions 132A′, 132B′of the two flanges 132A, 132B, the bottom edge portions 132A″, 132B″ of the two flanges 132A, 132B and the bottom edge portion 130A of the second portion blank 130.

As illustrated in FIG. 2, a close up view of a section of side portion 110A of a battery can 100, in accordance with the present disclosure, includes a first portion 112 having a first contour 112A and a second portion 116 having second contour 116A, the first portion 112 and the second portion 116 defining an internal battery volume 120 (not shown).

A section of the first contour 112A, of the first portion 112 of the battery can 100, is defined by the first side edge portion 122A of the first portion blank 122, the first flange edge portion 124A of the flange 124, the third flange edge portion 124C of the flange 124.

A section of the second contour 116A of the second portion 116, of the battery can 100, is defined by a side edge portion 132A′and a bottom edge portion 132A″ of the flange 132A.

The second contour 116A of the second portion 116 corresponds to the first contour 112A of the first portion 112.

In one non-limiting embodiment of the present disclosure as generally illustrated in FIG. 3, a method 1000 for making a battery can 100 includes: producing 1300 at least one first battery can portion and at least one second battery can portion, using a first manufacturing process; joining 1500 the at least one first battery can portion and the at least one second battery can portion, using a second manufacturing process, different from the first manufacturing process; and inspecting 1600 the battery can 100 to verify the joining 1500 between the at least one first portion and the at least one second portion.

In one non-limiting example of the present disclosure, as further illustrated in FIG. 3, a method for making 1000 a battery can 100 includes: identifying 1100 an internal battery volume 120; generating a prismatic model 1200 of the battery can 100, wherein the battery can 100 includes a first portion 112 having a first contour 112A and a second portion 116 having a second contour 116A; producing 1300 a first portion blank 122 and a second portion blank 130, using a first manufacturing process 1310; modifying 1400 the first portion blank 122 and the second portion blank 130, using a second manufacturing process 1410, to create the flanges 124, 132A and 132B, which define the first contour 112A of the first portion 112 and the second contour 116A of the second portion 116; joining 1500 the first portion 112 having the first contour 112A and the second portion 116 having the second contour 116A, using a third manufacturing process 1510 to form the battery can 100; and inspecting 1600 the battery can 100 to verify joining 1500 between the first portion 112 and the second portion 116.

In one non-limiting example of the present disclosure, the second manufacturing process 1410 may be different from the first manufacturing process 1310.

In one non-limiting example of the present disclosure, the first manufacturing process 1310 may be a cutting process, for example, but not limited to, a high speed precision laser cutting process, and the second manufacturing process 1410 may be a folding process, for example, but not limited to, a die bending process.

The first manufacturing process 1310 produces the first portion blank 122 and the second portion blank 130, each having uniform thickness and a length L that may be greater than 350 millimeters.

The second manufacturing process 1410 forms at least one flange 124 on the first portion blank 122, to create the first contour 112A and at least one flange 132A, 132B on the second portion blank 130 to create the second contour 116A.

The first portion blank 122 includes a bottom portion 126 that is bent to form the at least one flange 124 to create the first contour 112A.

The second portion blank 130 includes opposing side portions 134A, 134B that are bent to form two flanges 132A, 132B to create the second contour 116A.

In one non-limiting example of the present disclosure, the method 1000 may include verifying 1450 the first contour 112A of the first portion 112 substantially corresponds to or matches the second contour 116A of the second portion 116, prior to joining 1500 the first portion 112 and the second portion 116, using the third manufacturing process 1510.

In one non-limiting example of the present disclosure, the third manufacturing process 1510 may include a welding process, for example, but not limited to a laser welding process.

Joining 1500 the first portion 112 and the second portion 116 may include creating 1550 seams 140 at an interface 140′ between the first contour 112A of the first portion 112 and the second contour 116A of the second portion 116 of the battery can 100.

Inspecting the battery can 100 may include verifying 1610 that the battery can 100 is hermetically sealed at the seams 140 at the interface 140′ between the first portion 112 and the second portion 116 of the battery can 100.

In one non-limiting example of the present disclosure, identifying 1100 an internal battery volume 120 may be based on a target capacity.

In one non-limiting embodiment of the present disclosure, at least one safety vent, schematically illustrated at 150, may be provided in the battery can 100, which may provide improved thermal runaway protection/propagation strategies.

In one non-limiting embodiment of the present disclosure, a method 1000 may include applying an insulation coating (not shown) to the battery can 100. The insulation coating may be applied to one or more of an inside surface 160 of the battery can 100, an outside surface 162 of the battery can 100 and seams 140, to which the insulation coating can be applied internal and/or external to the battery can.

In one non-limiting example of the present disclosure, an insulation coating (not shown), may be applied on an inside surface 160 of at least one of the first portion 112 and the second portion 116 of the battery can 100, which may simplify a battery cell manufacturing process.

As illustrated in FIG. 3A, a method of providing 2000 at least one safety vent, schematically illustrated at 150, in the battery can 100 may include determining 2100 at least one location for the at least one safety vent, preparing 2200 the battery can 100 for installation of the at least one safety vent, and 2300 installing the at least one safety vent.

Preparing 2200 the battery can 100 for installation of the at least one safety vent may include determining 2210 at least one required area for the at least one safety vent and laser cutting 2220 the at least one required area for the at least one safety vent in at least one of the first portion 112 and the second portion 116 of the battery can 100.

Installing 2300 the at least one safety vent may include laser welding 2310 the at least one safety vent at the at least one required area.

The method of providing 2000 at least one safety vent, schematically illustrated at 150, in the battery can 100, may be included in the method for making 1000 the battery can 100.

As illustrated in FIG. 4, an exploded view of a battery can 200, in accordance with the present disclosure, includes a battery can extrusion portion 212A having a U-shaped channel, which defines a first contour 214A and at least one stamped metal portion 216, which defines a second contour 224 that corresponds to the first contour 214A of the battery can extrusion portion 212A.

As illustrated in FIG. 7, a metal billet 330 goes through an extrusion process 3300 to form a battery can extrusion 214. The battery can extrusion 214 goes through a cutting process 3400 to create at least one battery can extrusion portion 212A.

Referring back to FIG. 4, the at least one battery can extrusion portion 212A includes side openings 218A′, 218A″, top edges 220A′, 220A″, an interior surface 222A and an exterior surface 223A.

The at least one battery can extrusion portion 212A includes a battery can length L, extending between the side openings 218A′, 218A″.

The length L of the at least one battery can extrusion portion 212A may be greater than 350 millimeters.

As illustrated in FIG. 7, in one non-limiting example of the present disclosure, a metal sheet 340 goes through a stamping process 3500 to form at least one stamped metal portion 216.

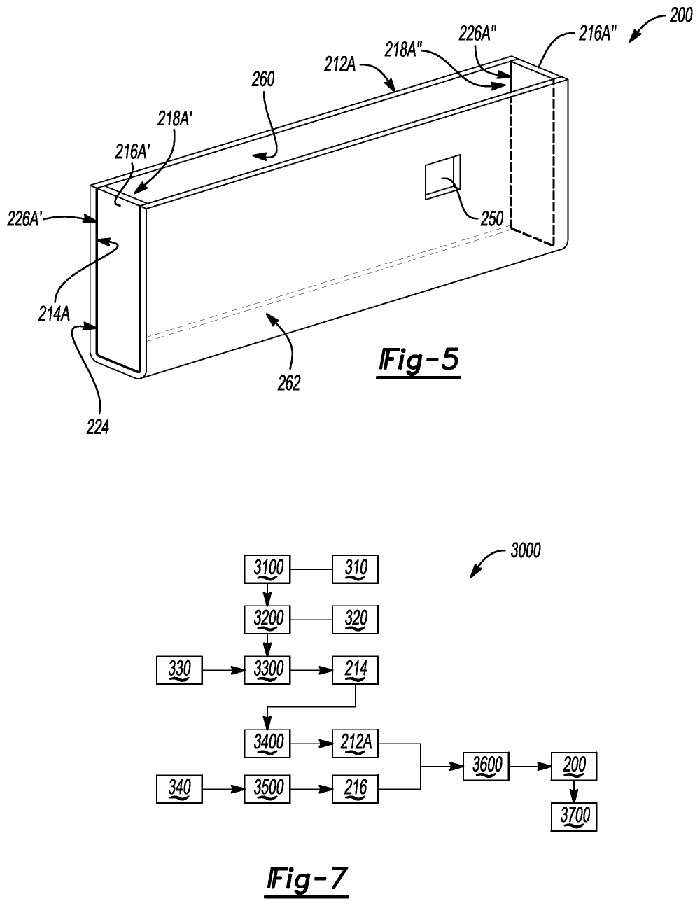

In one non-limiting embodiment of the present disclosure, as illustrated in FIG. 5, the at least one stamped metal portion 216 may include two stamped metal portions 216A′, 216A″, each of which may be respectively located at side openings 218A′, 218A″ of the at least one battery can extrusion portion 212A.

Each of the two stamped metal portions 216A′, 216A″ are joined to the at least one battery can extrusion portion 212A respectively at side openings 218A′, 218A″, to form seams 226A′, 226A″.

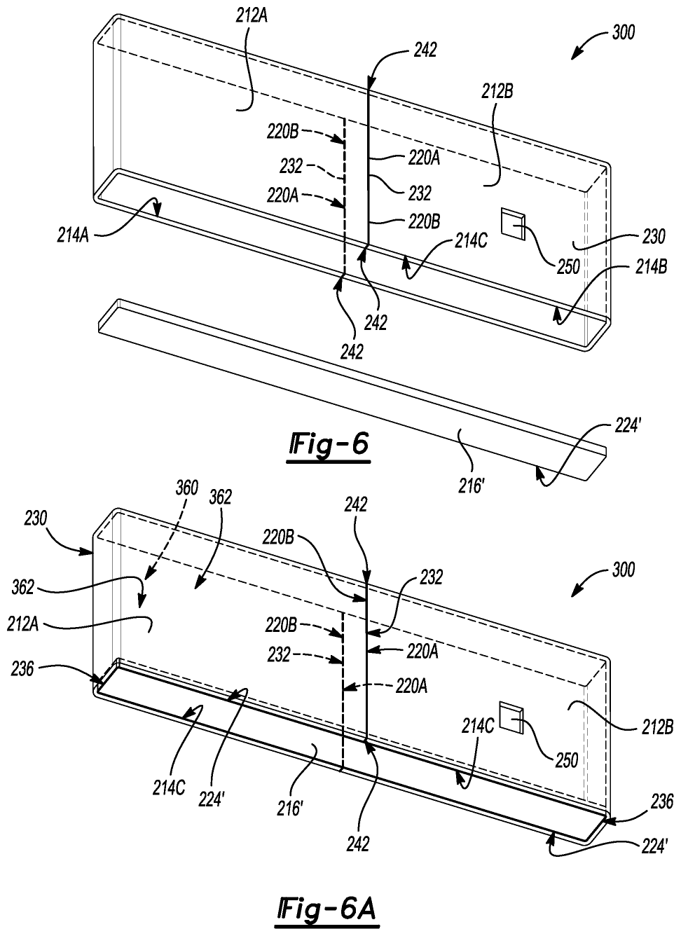

In another non-limiting embodiment of the present disclosure, as illustrated in FIG. 6, the at least one battery can extrusion portion 212A may include two battery can extrusion portions 212A, 212B.

The two battery can extrusion portions 212A, 212B are joined to one another, top edges 220A to top edges 220B, respectively, creating seams 232 at the top edges 220A of the battery can extrusion portion 212A and the top edges 220B of the battery can extrusion portion 212B, to form a battery can extrusion tube 230.

The battery can extrusion tube 230 includes a third contour 214C, defined by the first contours 214A and 214B of the battery can extrusion portions 212A and 212B.

At least one stamped metal portion 216′ includes a fourth contour 224′, corresponding to the third contour 214C of the battery can extrusion tube 230.

As illustrated in FIG. 6A, the at least one stamped metal portion 216′ is joined to the battery can extrusion tube 230, creating seams 236 between the third and fourth contours 214C, 224′.

In one non-limiting embodiment of the present disclosure, as illustrated in FIG. 7, a method for making 3000 a battery can 200, 300 includes: identifying 3100 battery can 200, 300 dimensions and features 310, including a battery can length L; providing 3200 an extrusion die 320 with a channel opening and features that correspond with the identified battery can 200, 300 dimensions and features 310; extruding 3300 a metal material 330 through the extrusion die 320 to form a battery can extrusion 214; cutting 3400 the battery can extrusion 214 into at least one battery can extrusion portion 212A having the identified battery can length L; stamping 3500 at least one stamped metal portion 216 from at least one metal sheet 340, using a stamping process; joining 3600 the at least one stamped metal portion 216 to the at least one battery can extrusion portion 212A, using a laser welding process; and inspecting 3700 the battery can to verify joining between the at least one stamped metal portion 216 and the at least one battery can extrusion portion 212A.

In one non-limiting example of the present disclosure, the at least one battery can extrusion portion 212A may include two side openings 218A′, 218A″.

Joining the at least one stamped metal portion 216 to the at least one battery can extrusion portion 212A may include joining two stamped metal portions 216A′, 216A″ to the at least one battery can extrusion portion 212A, such that one of the two stamped metal portions 216A′, 216A″ is joined at one of the two side openings 218A′, 218A″ and the other of the two stamped metal portions 216A′, 216A″ is joined at the other of the two side openings 218A′, 218A″.

In one non-limiting example of the present disclosure, joining 3600 the at least one stamped metal portion 216 to the at least one battery can extrusion portion 212A includes: joining 3600 two battery can extrusion portions 212A, 212B to one another to form a battery can extrusion tube 230 and joining at least one stamped metal portion 216′ to the battery can extrusion tube 230.

Joining the two battery can extrusion portions 212A, 212B to form the battery can extrusion portion tube 230 includes creating seams 232 at an interface 242 between the two battery can extrusion portions 212A, 212B.

Joining the at least one stamped metal portion to the at least one battery can extrusion portion tube 230 includes creating seams 236 between the third contour 214C of at least one stamped metal portion 216′ and the fourth contour 224′ of the at least one battery can extrusion portion tube 230.

Inspecting the battery can 300 includes verifying that the battery can 300 is hermetically sealed at the seams 232, between the two battery can extrusion portions 212A, 212B, and the seams 236 between the at least one stamped metal portion 216′ and the at least one battery can extrusion portion tube 230.

In one non-limiting embodiment of the present disclosure, the method of providing 2000 at least one safety vent, schematically illustrated at 150, in the battery can 100, as illustrated in FIG. 3A, may also be included in the method for making 3000 the battery can 200, 300, to provide at least one safety vent, schematically illustrated at 250 in battery can 200, 300, which may provide improved thermal runaway protection/propagation strategies.

Providing the at least one safety vent, schematically illustrated at 250, in the battery can 200, 300 includes: determining 2100 at least one location for the at least one safety vent, preparing 2200 the battery can for installation of the at least one safety vent; and installing 2300 the at least one safety vent.

In one non-limiting embodiment of the present disclosure, the method 3000 may include applying an insulation coating (not shown) to the battery can 200, 300. The insulation coating may be applied to one or more of an inside surface 260, 360 of the battery can 200, 300, an outside surface 262, 362 of the battery can 200, 300 and seams 226A′, 226A″, 232, 236, to which the insulation coating can be applied internal and/or external to the battery can 200, 300.

In one non-limiting example of the present disclosure, an insulation coating (not shown) may be applied on at least an inside surface 360 of at least one of the battery can extrusion portion tube 230 and the at least one stamped metal portion 216′, which may simplify a battery cell manufacturing process.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A method for making a battery can, comprising:
identifying an internal battery volume;
generating a prismatic model of the battery can, wherein the battery can includes a first portion having a first contour and a second portion having a second contour;
producing a first portion blank and a second portion blank, using a first manufacturing process;
modifying the first portion blank and the second portion blank, using a second manufacturing process, to create the first contour and the second contour;
joining the first portion having the first contour and the second portion having the second contour, using a third manufacturing process; and
inspecting the battery can to verify the joining between the first portion and the second portion.

2. The method as recited in claim 1, wherein the first manufacturing process is a cutting process and wherein the second manufacturing process is a folding process.

3. The method as recited in claim 2, wherein the first manufacturing process is a cutting process, wherein the cutting process includes using a high precision laser cutting process to produce the first portion blank and the second portion blank.

4. The method as recited in claim 2, wherein the second manufacturing process is a folding process, wherein the folding process includes a die bending process that forms at least one flange on the first portion blank to create the first contour and at least one flange on the second portion blank to create the second contour.

5. The method as recited in claim 4, wherein the first portion blank includes a bottom portion that is bent to form the at least one flange to create the first contour and the second portion blank includes opposing sides that are bent to form two flanges to create the second contour.

6. The method as recited in claim 1, comprising: verifying the first contour of the first portion substantially matches the second contour of the second portion, prior to joining the first portion and the second portion, using the third manufacturing process.

7. The method as recited in claim 1, wherein the third manufacturing process is a laser welding process; wherein joining the first portion and the second portion includes creating seams between the first portion and the second portion of the battery can; and wherein inspecting the battery can includes verifying that the battery can is hermetically sealed at the seams between the first portion and the second portion of the battery can.

8. The method as recited in claim 1, wherein identifying the internal battery volume is based upon a target capacity.

9. The method as recited in claim 1, comprising: providing at least one safety vent in the battery can.

10. The method as recited in claim 9, wherein providing the at least one safety vent in the battery can includes: determining at least one location for the at least one safety vent, preparing the battery can for installation of the as least one safety vent; and installing the at least one safety vent.

11. The method as recited in claim 1, comprising: applying an insulation coating on one or more of an inside surface, an outside surface and a seam of the battery can.

12. A method for making a battery can, comprising:
identifying battery can dimensions and features, including a battery can length;
providing an extrusion die with a channel opening and features that correspond with the identified battery can dimensions and features;
extruding a metal material through the extrusion die to form a battery can extrusion;
cutting the battery can extrusion into at least one battery can extrusion portion having the identified battery can length;
stamping at least one stamped metal portion, using a stamping process;
joining the at least one stamped metal portion to the at least one battery can extrusion portion, using a laser welding process; and
inspecting the battery can to verify joining between the at least one stamped metal portion and the at least one battery can extrusion portion.

13. The method as recited in claim 12, wherein the at least one battery can extrusion portion includes two side openings; and wherein joining the at least one stamped metal portion to the at least one battery can extrusion portion includes: joining two stamped metal portions to the at least one battery can extrusion portion.

14. The method as recited in claim 13, wherein one of the two stamped metal portions is joined to one of the two side openings and the other of the two stamped metal portions is joined to the other of the two side openings.

15. The method as recited in claim 12, wherein joining the at least one stamped metal portion to the at least one battery can extrusion portion includes: joining two battery can extrusion portions to one another to form a battery can extrusion portion tube and joining the at least one stamped metal portion to the battery can extrusion portion tube.

16. The method as recited in claim 12, wherein joining the at least one stamped metal portion to the at least one battery can extrusion portion includes creating seams between the at least one stamped metal portion and the at least one battery can extrusion portion; and wherein inspecting the battery can includes verifying that the battery can is hermetically sealed at the seams between the at least one stamped metal portion and the at least one battery can extrusion portion.

17. The method as recited in claim 12, comprising: providing at least one safety vent in the battery can.

18. The method as recited in claim 16, wherein providing the at least one safety vent in the battery can includes: determining at least one location for the at least one safety vent, preparing the battery can for installation of the as least one safety vent; and installing the at least one safety vent.

19. The method as recited in claim 12, comprising: an insulation coating on one or more of an inside surface, an outside surface and a seam of the battery can.

20. A method for making a battery can, comprising:
manufacturing at least one first battery can portion and at least one second battery can portion, using a first manufacturing process;
joining the at least one first battery can portion and the at least one second battery can portion, using a second manufacturing process, different from the first manufacturing process; and
inspecting the battery can to verify the joining between the at least one first portion and the at least one second portion.
